(19) United States
(12) Patent Application Publication
(10) Pub. No.: US 2024/0019205 A1
(43) Pub. Date: Jan. 18, 2024

(54) FACILITY FOR PRODUCING GASEOUS METHANE BY PURIFYING BIOGAS FROM LANDFILL, COMBINING MEMBRANES AND CRYOGENIC DISTILLATION FOR LANDFILL BIOGAS UPGRADING

(71) Applicant: WAGA ENERGY, Eybens (FR)

(72) Inventor: Guénaël Prince, Lyon (US)

(21) Appl. No.: 18/034,717

(22) PCT Filed: Nov. 11, 2021
(86) PCT No.: PCT/EP2021/081343

§ 371 Date: May 1, 2023

Related U.S. Application Data
(63) Continuation of application No. 16/949,721, filed on Nov. 11, 2020, now abandoned.

(51) Int. Cl. F25J 3/02; F25J 3/04

(52) U.S. Cl. CPC F25J 3/0209; F25J 3/04169; F25J 2210/66; F25J 2220/66; F25J 2205/60

(57) ABSTRACT

A facility for producing gaseous biomethane by purifying biogas from landfill, comprising: • a compression unit, • a volatile organic compound (VOC) purification unit; • a membrane separation unit, • a CO₂ polishing unit, • a cryodistillation unit comprising a heat exchanger and a distillation column, • an O₂ depletion unit, • a dryer arranged.

Biogas is produced by the decomposition of organic matter: it is made of methane (CH₄), carbon dioxide (CO₂), and other impurities depending on the biogas source. It can be produced in digesters using inputs from agricultural or Waste Water Treatment Plants (WWTP) operations, or in landfills. Biogas can then be transformed into energy either as a fuel in internal combustion engines coupled with an alternator, thus producing electricity, or the biogas can be upgraded and transformed into Renewable Natural Gas (RNG). This RNG displaces equivalent volumes of fossil natural gas when injected into the Natural Gas (NG) pipelines. This second path of valorization is much more efficient on an energy basis, as it recovers more than 90% of the energy contained in the raw gas, compared to 35% in the case of electricity production (no heat valorization). RNG is more and more seen as an immediate and effective way to decarbonize the use of fossil NG.

The most important sources of biogas are landfills, but the biogas produced is highly polluted: the CH₄ must be separated from CO₂, hydrogen sulfide (H₂S), volatile organic chemicals (VOCs), siloxanes, and air gases (oxygen and nitrogen) prior pipe injection.

The Applicant has developed a breakthrough technology to transform the raw landfill gas, into clean RNG: the said technology named Wagabox® is disclosed in the patent FR-B-3046086 (US2019/0001263). This process and corresponding facility has multiple steps to remove the impurities:
Blower to suck the gas from the landfill and to feed the compressor
Active carbon (AC) filters for H₂S (or any other available technology)
Dryer to remove H₂O
Compression
PSA (Pressure Swing Adsorption) for VOCs
Membranes for CO₂: 1, 2 or 3 stages
PTSA (Pressure Temperature Swing Adsorption) for the remaining CO₂ at membrane system outlet
Cryodistillation for air gases (N₂ and O₂) removal from CH₄
Grid compression, as distillation occurs at low pressure.

It shall be noted that this technology can be applied for other gas which composition would be close to landfill biogas: for example, coal bed methane and coal mine methane are also gases that contain CO₂, air gases, and other pollutants.

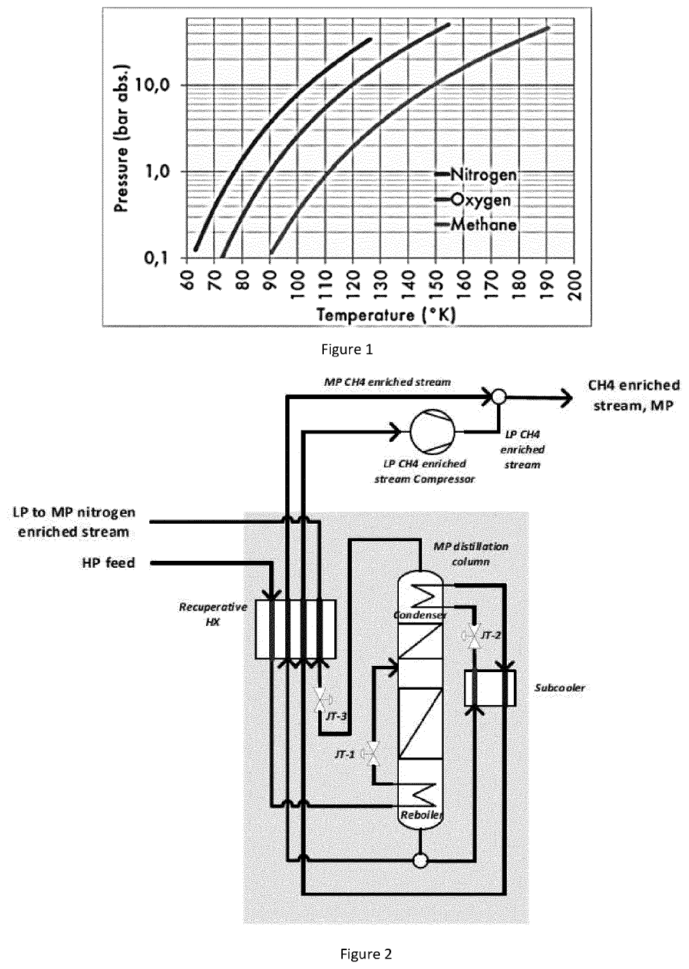

Cryodistillation (meaning distillation at cryogenic temperature) is a well-known process for separating nitrogen and methane. It is widely used in the oil & gas industry in order to separate nitrogen from methane when the gas field is nitrogen-enriched. This process uses equipment commonly named NRU (Nitrogen Removal Units). Cryodistillation is the most efficient separation process as methane and nitrogen demonstrate a great difference of volatility, meaning the separation is easy compared to a “warm” process like adsorption, or gas permeation membranes (see FIG. 1).

The separation of nitrogen and methane by distillation must be performed at low temperature, as a distillation requires partially liquefied components. At atmospheric to intermediate pressures (up to 300 psia), methane and nitrogen shall therefore be cooled down to low temperatures to liquefy them.

Multiple process schemes have been developed over the years; we describe hereafter a few of them, that are now considered state-of-the-art technologies:
Simple distillation column operated at medium to high pressure (typically 300 to 400 psia), operated by a closed-loop methane heat-pump system that provides both the reboiler and condenser duty. Energy consumption of this process is high.
Double column process: this process uses two distillations columns operating at two different pressures, that are thermally linked; the condenser for the high-pressure column provides heat to the reboiler of the low-pressure column. The process provides all the refrigeration for the separation through Joule-Thomson expansion of the fluid in the location chosen for the process. This process has great performances, but the methane recovery rate depends on the nitrogen content; if the nitrogen content drops below 30%, the methane recovery is reduced.
Simple distillation column operated at medium pressure (approximately 300 psia approximately), with a portion of the methane used as a refrigerant in the condenser of the distillation column, while the heat for the reboiler is provided by the feed gas prior to the Joule-Thomson discharge and introduction in the distillation column.

However, those NRU process have never been applied to biogas upgrading, because of the presence of oxygen along with methane and nitrogen. Indeed, oxygen boiling temperature is in between nitrogen and methane For example, at 14.7 psia pure nitrogen boils at 77.3K, pure oxygen at 90.2K and pure methane at 111.7K. As a consequence, oxygen will naturally concentrate in the distillation, leading to an enriched-oxygen mixture and a potentially explosive mixture with methane.

In order to solve this problem, the Applicant, developed an intrinsically safe process that allows the distillation of the mixture oxygen, nitrogen and methane without any concentration of oxygen, while maintaining very good performances (energy consumption, and methane recovery rate). This process is more detailed in the patent FR-B-3051892. This patented distillation technology, along with the patented combination of a membrane unit and distillation unit for RNG production (patent FR-B-3046086/US2019/0001263) are the base of the Wagabox® for upgrading landfill gas containing from below 2% nitrogen to above 25% of nitrogen.

The instant invention focuses on how to integrate another NRU distillation technology downstream from a conventional membrane unit, as disclosed in FR-B-3046086 (US2019/0001263).

The chosen NRU technology is the single-column, medium pressure, distillation process, as disclosed in patent U.S. Pat. No. 5,375,422.

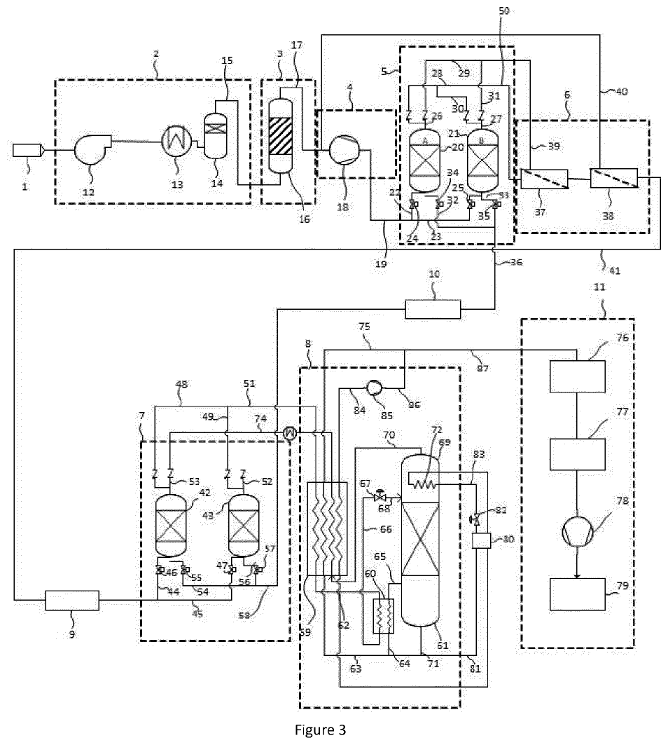

A typical process flow diagram (PFD) of a single column, medium pressure NRU, is shown on FIG. 2.

In this unit there are 3 levels of pressure:
High Pressure (HP): from 300 psia to 650 psia,
Medium Pressure (MP): from 145 psia to 300 psia,
Low Pressure (LP): 14.5 psia to 30 psia

The process takes advantage of discharging fluids from a higher pressure-level to a lower pressure-level to cool them down through Joule-Thomson (JT) expansion. The process being cryogenic, this is the cold source production, allowing to run continuously the unit without an external cold source. The hidden energy consumption is the gas compression electricity, as gas compression is energy consuming.

Here is a brief explanation of how the process works: the HP feed is introduced in a recuperative heat exchanger (HX), which purpose is to recover cold from the products coming out of the distillation; the MP product is vaporized and reheated during counter-flow through this heat exchanger, along with the nitrogen enriched stream, and the LP product. Consequently, the feed gas is cooled down. It is further cooled down in the reboiler, sharing the available heat at the bottom of the distillation to generate the ascending vapor. Feed gas is eventually discharged from HP to MP through the valve JT-1.

In the distillation column, the components are separated due to their difference of volatility at the distillation operating pressure (MP): liquid phase is enriched in methane while going down in the distillation column, while vapor is enriched in nitrogen. Differential temperature is governing the separation: the bottom of the distillation is at a higher temperature than the top. Oxygen splits into the liquid methane phase at the bottom, and vapor nitrogen phase at the top. It is not an object to assess if this separation in this process is safe considering the risk of oxygen enrichment in the distillation column.

A portion of MP liquid methane at the distillation bottom is sent to a sub-cooler, and then discharged at LP in the condenser. This discharge further cools down the liquid methane, that is now cold enough to act as a refrigerant for the condenser.

Two methane-enriched products are recovered at ambient temperature at the outlet of the recuperative HX: 1. the LP product, and 2. the MP product. A LP product compressor can then be installed in order to mix the products together and deliver a single product at MP.

As mentioned above, the purpose of the present invention is to integrate this specific NRU distillation technology downstream from a conventional membrane unit, as disclosed in FR-B-3046086 (US2019/0001263).

The Applicant has discovered that such an integration was possible with the use of a booster/compressor, i.e arranged downstream the membrane unit or downstream the PTSA.

According to the invention:
a compressor means a machine able to compress a gas from the atmospheric pressure,
a booster/compressor means a compressor able to compress the gas at a pressure above the pressure of the same gas already compressed by a compressor.

In more details, an important first element of the design is the difference between the operating pressure of the membrane (between 110 psi to 230 psi) and the feed pressure requested by the single-column NRU (300 psi to 600 psi).

The applicant proposes to arrange a a booster downstream of the membrane unit, and upstream the NRU, that will increase the pressure of the product delivered by the membrane (with a low CO₂ content, almost no H₂O, and low impurities content, but enriched in methane and nitrogen).

In other words, the invention concerns a facility for producing gaseous biomethane by purifying biogas from landfill, comprising:
a compression unit for compressing an initial gas flow of the biogas to be purified,
a volatile organic compound (VOC) purification unit arranged downstream of the compression unit to receive the compressed initial flow of the biogas and comprising at least one adsorber loaded with adsorbents capable of reversibly adsorbing VOCs to thereby produce a VOC-depleted gas flow;
a membrane separation unit arranged downstream of the VOC purification unit to receive the VOC-depleted gas flow and subject the VOC-depleted gas flow to at least one membrane separation to partially separate the CO₂ and O₂ from the gas flow producing a methane rich retentate,
a CO₂ polishing unit arranged downstream of the membrane separation unit to receive the methane rich retentate from the membrane, wherein the CO₂ polishing unit comprises at least one adsorber loaded with adsorbents capable of reversibly adsorbing the majority of remaining CO₂ from the methane rich retentate to produce a CO₂-depleted gas flow;
a cryodistillation unit comprising a heat exchanger and a distillation column, arranged downstream of the CO₂ polishing unit to receive the CO₂ depleted gas flow and subject the CO₂ depleted gas flow to a cryogenic separation to separate O₂ and N₂ from the CO₂ depleted gas flow and to produce a gas distillate,
wherein a booster is arranged downstream the membrane separation unit and upstream the cryodistillation unit and the cryodistillation unit comprises further a subcooler, the said cryodistillation unit being capable to produce two methane enriched flows respectively a low pressure (LP) and a medium pressure (MP) methane enriched flows, and wherein it further comprises a compressor capable to compress the low pressure (LP) methane enriched flow in order to mix it with the medium pressure (MP) methane enriched flow, to produce a medium pressure (MP) methane enriched flow

Practically, before the step of compression of the initial gas flow, the gas to be purified is subjected to a drying step and then to a desulfurization step or vice versa.

The drying step consists of pressurizing the gas from 20 to a few hundred hectopascals (500 hPa relative maximum), further preventing air from entering the pipes. The pressurizing enables a preliminary drying to be carried out by cooling the biogas to between 0.1 and 10° C., to condense the water vapor. The gas flow exiting therefore has a pressure of between 20 and 500 hPa (between 20 and 500 mbar) and a dew point of between 0.1° C. and 10° C. at the outlet pressure.

The desulfurization step enables the capture of H₂S in order to meet the quality requirements of the network and to avoid a too quick degradation of the materials in the rest of the process.

Furthermore, it is important to have a capture step which fixes the H₂S in a stable form (such as solid sulfur) to avoid any emissions harmful to health or the environment (olfactory nuisance, formation of SOx). This treatment is carried out preferably with activated carbon or iron hydroxides in vessels suitably sized for the quantity of H₂S to be treated. H₂S is thus transformed into solid sulfur. The gas flow exiting contains in practice less than 5 mg/Nm³ of H₂S.

The gas to be processed is then compressed. The compression is carried out at a pressure of between 0.8 and 2.4 megapascals (between 8 and 24 bars). This pressure is necessary to enable the subsequent steps to be carried out and to decrease the equipment size.

The next step consists in purifying the gas flow from VOCs. Practically, the gas flow to be purified is passed over at least one pressure swing adsorber (PSA), advantageously 3 PSA loaded with adsorbents capable of reversibly adsorbing the VOCs. This step enables the biogas to be purified from VOCs (light hydrocarbons, mercaptans, siloxanes, etc.), which are incompatible with the quality requirements of the network, and which risk polluting the next steps of the purification (notably the membranes).

Advantageously, at least two PSAs are used so as to be able to implement the process continuously. Indeed, when the first PSA is saturated with VOCs, it is substituted by the second PSA which has itself been previously regenerated.

Preferably, the PSA(s) is/are regenerated by the permeate from the membrane separation. This permeate is composed mainly of CO₂ and has a very low CH₄ content. In practice, the gas flow at the regeneration outlet is oxidized.

The next step which is optional consists in adding a further step of purification of the gas flow from VOCs by filtering the VOC-depleted gas flow in at least one filter loaded with activated carbon. Advantageously, there are 2 filters to be able to implement the process continuously. Indeed, when the first filter is saturated with VOCs, it is substituted by the second filter which has itself been previously regenerated.

In the next step, the CO₂ is removed from the gas flow. Practically, the VOC-depleted gas flow exiting the PSA, or optionally the filter loaded with activated carbon, is subjected to at least one membrane separation to partially separate the CO₂ and O₂ from the gas flow. More precisely, the selective membrane separation enables a first effective purification of the biogas to be performed by separating a large part of the CO₂ (more than 90%) as well as some of the O₂ (around 50% and generally at least 30%, advantageously between 30 and 70%). Membrane purification may be composed of 1, 2, 3 or 4 membrane stages depending on the characteristics of the biogas.

In a particular embodiment, two successive membrane separations are carried out. More specifically:
the VOC-depleted gas flow exiting the PSA is subjected to a first membrane separation,
the PSA is regenerated by means of the permeate from said first membrane separation,
the methane rich retentate from the first separation is subjected to a second membrane separation,
the permeate from the second membrane separation is reintroduced upstream of the compression.

Recirculating the permeate from the second membrane separation, which still contains CO₂ and CH₄, thus improves the yield of CH₄. In practice, the permeate is reintroduced between the dryer and the compressor.

Membranes unit can easily deliver a product containing less than 0.5% vol of CO₂ (that is 5,000 ppmv), for example down to 2,000 ppmv. But lower levels of CO₂ are too challenging and will result in both high methane losses from the process, and high energy consumption.

One of the well-known benefits of a cryogenic MP distillation is its tolerance to impurities like CO₂: CO₂ solubility is increased while increasing the pressure, and in addition a higher distillation pressure leads to higher operating temperatures, which in turn reduce the risk of freezing CO₂ in the heat exchangers. A common maximum CO₂ content in methane prior to liquefaction is 50 ppmv. MP cryogenic distillation can tolerate up to 200 ppmv without any operating problem (see Gregory L. Hall, BCCK VP Sales, Nitech™ Nitrogen Rejection Technology: Efficiency Without the Complexity Typically Associated with Nitrogen Rejection (Hydrocarbon Processing, July 2005).

Unfortunately, the maximum level of CO₂ allowed in the NRU is far above the minimum level of CO₂ content in the product from the membrane unit. Consequently, a CO₂ removal unit is arranged in between the membrane unit and the NRU. This step is carried out by a PTSA. The choice of a PTSA enables the size of the vessel and the cycle times to be reduced.

In a PTSA unit, CO₂ is adsorbed under pressure, while regeneration is achieved at low pressure and high temperature.

The adsorbent will notably be selected from the group comprising zeolites.

Advantageously, 2 PTSAs are used so as to be able to implement the process continuously. Indeed, when the first PTSA is saturated with CO₂, it is substituted by the second PTSA which has itself been previously regenerated.

In order to regenerate the PTSA, a clean stream (meaning containing no CO₂, no water and no other impurities) may be used to heat the media and to remove the CO₂ and other impurities adsorbed. This stream can be the vent gas of the MP distillation column, after discharge through a Joule-Thomson (JT) valve, as regeneration shall occur at a lower pressure than adsorption.

Another option is to use a portion of the clean gas at the outlet of the vessel in adsorption in the PTSA, to discharge the pressure and to use it as the elution stream for the vessel in regeneration mode.

The PTSAs are dimensioned so as to avoid the biomethane produced containing more than 2.5% CO₂ in order to guarantee a quality compatible with the requirements for commercialization.

Two options are available for integrating the PTSA unit and the booster upstream of the MP distillation unit.

According to a first embodiment, the booster is arranged downstream the membrane unit and upstream the CO₂ polishing unit.

The advantage of this embodiment is to adsorb CO₂ and other impurities at a higher pressure (300 to 600 psi), which is favorable for adsorption: adsorption capacity of the media increases with partial pressure of CO₂. This configuration would also allow the adsorption of any remaining oil originating from the booster.

According to a second embodiment, the booster is arranged downstream the CO₂ polishing unit and upstream the distillation unit.

The next step of the method of the invention consists in separating the N₂ and the O₂ then collecting the CH₄ rich flow resulting from this separation. Practically, the CO₂ depleted gas flow exiting the PTSA is subjected to a cryogenic separation in a cryodistillation unit.

The cryodistillation unit comprises a heat exchanger, a distillation column and a subcooler. The heat exchanger is arranged to receive the CO₂ depleted gas flow from the CO₂ polishing unit and to cool the CO₂ depleted gas flow, the distillation column is arranged to receive the cooled CO₂ depleted gas flow from the heat exchanger and separates the CO₂ depleted gas flow into a liquid CH₄ and a gas distillate.

In more details:
the HP CO₂ depleted gas flow is cooled in the heat exchanger to produce a cooled CO₂ depleted gas flow,
the cooled HP CO₂ depleted gas flow is at least partially condensed in a condenser-reboiler able to condense the cooled CO₂ depleted gas flow by heat exchange with a first portion of the liquid enriched in CH₄ drawn off a bottom of the distillation column to produce a partially condensed cooled HP CO₂ depleted gas flow,
the partially condensed cooled HP CO₂ depleted gas flow is decompressed into means for decompression to produce a MP partially condensed cooled CO₂ depleted gas flow containing a liquid fraction and a vapor fraction,
the liquid fraction and the vapor fraction are separated from the decompressed partially condensed cooled CO₂ depleted gas flow,
The liquid fraction of the MP partially condensed cooled CO₂ depleted gas flow is sent to a level of the distillation column by a conduit,
a MP liquid enriched in CH₄ is drawn off a bottom of the distillation column by a conduit,
the first portion of the MP liquid enriched in CH₄ drawn off a bottom of the distillation column is vaporized in the condenser-reboiler to produce a vaporized bottom stream,
the vaporized bottom stream is injected in the distillation column by a conduit at a level below the level at which the liquid fraction of the MP partially condensed cooled CO₂ depleted gas flow is injected and the vaporized bottom stream and the liquid fraction enter into contact,
a second portion of the MP liquid enriched in CH₄ drawn off a bottom of the distillation column is vaporized in the heat exchanger to produce a first MP gas flow enriched in CH₄,
a MP gas flow enriched in O₂ and N₂ is drawn off from the head of the distillation column by a conduit,
the MP gas flow enriched in O₂ and N₂ is decompressed into means for decompression to produce a LP gas flow enriched in O₂ and N₂,
the LP gas flow enriched in O₂ and N₂ is heated in the heat exchanger,
a third portion of the MP liquid enriched in CH₄ drawn off a bottom of the distillation column is sent a subcooler to produce a MP cooled liquid flow enriched in CH₄,
the MP cooled liquid flow enriched in CH₄ is decompressed into means for decompression to produce a cooled LP liquid flow enriched in CH₄,
the cooled LP liquid flow enriched in CH₄ is sent to a condenser arranged in the head of the distillation column,
the cooled LP liquid flow enriched in CH₄ is sent to the subcooler and is vaporized in the heat exchanger to produce a LP gas flow enriched in CH₄,
the LP gas flow enriched in CH₄ is compressed in a compressor to produce a second MP gas flow enriched in CH₄,
the first and second gas flow enriched in CH₄ are mixed in the same pipe.

As summary, distillation is a process operated at low pressure, as lowering the operating pressure increases the difference of volatility between the molecules. As a result, the separation is easier. On the other hand, a NRU, whose purpose is to separate methane from nitrogen, can still be operated at MP to HP, as there is a high difference of volatility between methane and nitrogen. When the NRU separates oxygen from methane, operating at MP to HP can be a drawback, and separation can be more difficult, because the difference of volatility between methane and oxygen is lower than that of methane and nitrogen. As a result, the enriched methane product can still contain oxygen, at a level that is higher than the maximum level allowed by the interconnecting gas grid (gas pipeline) operator.

The gas grid specifications, which specify the quality requirements of the RNG, differ from country to country, and from state to state especially in the USA. This is particularly true when it relates to oxygen content in the RNG. Depending on the grid owners, oxygen limits can vary from 1% vol (10,000 ppmv) down to 10 ppmv. However, 2,000 ppmv seems to be the most encountered specification.

In case the MP single column distillation unit cannot meet the oxygen pipeline specification, an additional treatment has to be done on the product.

The solution of the invention consists in adding an O₂ depletion unit that will remove oxygen from the RNG.

In the deoxo, oxygen is converted into CO₂ and H₂O, by a standard combustion with methane according to the following reaction: CH₄+2.O₂→CO₂+2.H₂O. Hydrogen may also be used instead of methane.

According to a first embodiment, the facility further comprises an O₂ depletion unit (also named deoxo) arranged downstream the cryodistillation unit to receive the medium pressure methane enriched flow capable of converting the O₂ present in medium pressure methane enriched flow into CO₂ and H₂O to produce an O₂ depleted gas flow, and a dryer, especially a TSA (Temperature Swing Adsorption) arranged downstream the O₂ depletion unit capable of removing H₂O from the O₂ depleted gas flow.

In the deoxo, the reaction is generally made on a catalyst, especially a platinum or platinium/rhodiumbased catalyst, in order to decrease the reaction temperature. Then, the moisture (H₂O) can easily be removed with a dryer, as for example a TSA (Temperature Swing Adsorption). In the TSA, water is removed on a dedicated zeolite or alumina based adsorbent, while another TSA is heat regenerated.

If necessary, a booster can be added downstream the TSA, in case the optimum operating pressure of the deoxo and the TSA is less than the grid pressure.

Practically, the specification of the grid is typically between 10 and 15 bars for the gas supply network, and between 80 and 100 bars for the gas transportation network.

According to another embodiment, the O₂ depletion unit is arranged downstream the booster and upstream the CO₂ polishing unit.

In this case, the CO₂ and water produced by the combustion can be removed in the PTSA upstream of the distillation unit. This configuration has the advantage to save on TSA equipment. But the flow treated is more important as it contains the vent gas of the distillation (and not only the RNG), and the deoxo may have to process gas containing impurities at the membrane outlet.

In this specific embodiment, the CO₂ polishing unit comprises at least one adsorber loaded with adsorbents capable of reversibly adsorbing the majority of remaining H₂O contained in the O₂ depleted gas flow.

Alternatively, the facility comprises a dryer, especially a TSA arranged downstream the O₂ depletion unit and upstream the CO₂ polishing unit.

According to another embodiment, the O₂ depletion unit is arranged downstream the membrane unit and upstream the booster.

The invention and resulting advantages will become clear from the following example supported by the attached figures.

FIG. 1 is a graph showing vapor pressure curves of methane, nitrogen, and oxygen,

FIG. 2 is a schematic illustration of a facility in accordance with an embodiment of the disclosure showing a single-column NRU, with methane loop to act as a refrigerant,

FIG. 3 is a schematic representation of a facility of the invention according to a preferred embodiment.

The facility comprises a source of biogas to be treated (1), a drying unit (2), a desulfurization unit (3), a compression unit (4), a VOC purification unit (5), a first CO₂ polishing unit (6), a second CO₂polishing unit (7), a cryodistillation unit (8), an oxidation unit (10) and finally a methane gas recovery unit (11). All the apparatus are connected to each other by pipes.

The drying unit (2) comprises a pressurizer (12), a heat exchanger (13) and a gas liquid separation vessel (14). As already mentioned, this step enables the gas to be pressurized from 20 to a few hundred hectopascals (500 hPa (from 20 to a few hundred millibars (500 mbar) relative maximum). Cooling the gas to between 0.1 and 10° C. enables it to be dried. The gas flow exiting (15) therefore has a pressure of between 20 and 500 hPa (between 20 and 500 mbar) and a dew point of between 0.1° C. and 10° C. at the outlet pressure.

The desulfurization unit (3) is in the form of a tank (16) loaded with activated carbon or iron hydroxides. This unit enables the H₂S to be captured and transformed into solid sulfur. The flow of gas exiting (17) contains in practice less than 5 mg/Nm³ of H₂S.

The compression unit (4) is in the form of a lubricated screw compressor (18). This compressor compresses the gas flow (17) to a pressure of between 0.8 and 2.4 megapascals (between 8 and 24 bars). The flow leaving is shown on FIGS. 1-3 by reference (19)

The VOC purification unit (5) comprises 2 PSAs (20, 21). They are loaded with adsorbents specifically selected to allow adsorption of the VOCs, and the later desorption during regeneration. The PSAs function in production and regeneration mode alternately.

In production mode, the PSAs (20, 21) are supplied with gas flow at their lower part. The pipe in which the gas flow (19) circulates splits into two pipes (22, 23), each equipped with a valve (24, 25) and supplying the lower part of the first PSA (20) and the second PSA (21) respectively. The valves (24, 25) will be alternately closed depending on the saturation level of the PSAs. In practice, when the first PSA is saturated with VOCs, valve (24) is closed and valve (25) is opened to start loading the second PSA (20). From the upper part of each of the PSAs leads a pipe (26 and 27) respectively. Each of them splits into 2 pipes (28, 29) and (30, 31) respectively. The VOC-purified flow coming from the first PSA circulates in pipe (28) while the VOC-purified flow coming from the second PSA circulates in pipe (30). The two pipes are joined so as to form a single pipe (50) supplying the CO₂ polishing unit (6).

In regeneration mode, the regenerating gas circulates in the pipes (29, 31). It emerges at the lower part of the PSA. Thus, a pipe (32) equipped with a valve (34) leads from the first PSA (20). A pipe (33) equipped with a valve (35) leads from the second PSA (21). Pipes (32, 33) are joined upstream of the valves (34, 35) to form a common pipe (36). This pipe is connected to the oxidation unit (10).

Optionally, the process comprises a further step of purification of the gas flow from VOCs by filtering the VOC-depleted gas flow in at least one filter loaded with activated carbon (non represented). Advantageously, there are 2 filters to be able to implement the process continuously. Indeed, when the first filter is saturated with VOCs, it is substituted by the second filter which has itself been previously regenerated.

The first CO₂ polishing unit (6) combines two membrane separation stages (37, 38). The membranes are selected to enable the separation of around 90% of the CO₂ and around 50% of the O₂.

The permeate loaded with CO₂, O₂ and a very small proportion of CH₄ coming from the first membrane separation is used to regenerate the PSAs (20, 21). It circulates in pipe (39) then alternately in pipes (29, 31) depending on the operating mode of the PSAs. The methane rich retentate from the first separation is then directed towards the second membrane separation (38). The permeate from the second membrane separation is recycled by means of a pipe (40) connected to the main circuit upstream of the compressor (18). This step enables a gas circulating in the conduit (41) with less than 3% CO₂ and with a CH₄ yield greater than 90% to be produced.

The second CO₂ polishing unit (7) combines 2 PTSAs (42, 43). They are loaded with zeolite-type adsorbents. They are each connected to pipes according to a model identical to that described previously for the PSAs. They also function according to a production mode or a regeneration mode.

In production mode, the gas flow (41) alternately supplies the PTSAs (42, 43) by means of pipes (44, 45) each equipped with a valve (46, 47). The CO₂ purified gas flow from the PTSA (42) then circulates in pipe (48). The CO₂ purified gas flow from the PTSA (43) then circulates in pipe (49). The two pipes (48, 49) are connected to a single pipe (51) connected to the cryodistillation unit.

In regeneration mode, the regenerating gas circulates in the pipes (52, 53). It emerges in the lower part of the PTSAs. Thus, a pipe (54) equipped with a valve (55) leads from the first PTSA (42). A pipe (56) equipped with a valve (57) leads from the second PTSA (43). Pipes (54, 56) are joined upstream of the valves (55, 57) to form a common pipe (58). This pipe is connected to the oxydation unit (10).

In that example, the regeneration of the PTSA(s) is be made by the N₂ rich distillate (74) from the cryogenic separation.

In the illustrated embodiment, the membrane separation unit (6) is separated from the CO₂ polishing unit (7) by a booster (9) which is capable of increasing the pressure from between 110 psi to 230 psi to the feed pressure requested by distillation unit (300 psi to 600 psi).

In another embodiment which is not illustrated, the booster may be arranged downstream the PTSA as mentioned before.

The cryodistillation unit (10) is supplied by the pipe (51) in which the gas to be purified circulates. It contains 4 elements: a heat exchanger (59), a reboiler (60), a distillation column (61) and a subcooler (80).

The heat exchanger (59) is fed by the HP CO₂ purified gas flow (51). The flow has a pressure of between 5 and 25 bar absolute, preferably a pressure of between 8 and 15 bar absolute, a temperature of between 273 and 313 K, typically 288 K, and comprises between 50 and 100% methane, up to 50% of N₂ and up to 4% of O₂.

The HP CO₂ purified gas flow (51) is cooled and partially liquefied (62) to a temperature of between 100 and 200 K, in the heat exchanger (59) by exchange with a portion (63) of the distillate of the upcoming liquid enriched in CH₄ (71) drawn off a bottom of the distillation column, and with a gas flow enriched in O₂ and N₂ (70) drawn off from the head of the distillation column.

The cooled HP CO₂ depleted gas flow is then partially condensed. The cooled HP CO₂ depleted gas flow (62) is sent to a reboiler (60) where it is further cooled and partially condensed by heat exchange with a portion (64) by exchange with a portion (63) of the distillate of the upcoming liquid enriched in CH₄ (71) drawn off the bottom of the distillation column which is vaporized. The vaporized liquid enriched in CH₄ (65) is introduced at a lower level of the distillation column to generate a gas enriched in CH₄ for use in distillation.

The partially condensed cooled HP CO₂ depleted gas flow (66) is then expanded in a valve (67) which produces a high cooling of the expanded fluid (68) to the operating MP pressure of the distillation column (62), between 1 and 5 bar absolute.

The MP partially condensed cooled CO₂ depleted gas flow (68) contains a liquid fraction and a vapor fraction which are then separated in the head (69) of the column (62) to form a gas flow (70) enriched in O₂ and N₂ and a liquid flow (71) enriched in CH₄. The cooling of the head of the column is ensured by charging a condenser (72) with a portion (81) of the liquid (71) enriched in CH₄ drawn off the bottom of the distillation column and circulating in a the subcooler (80) before being decompressed from MP to LP in the valve (82) to produce a LP liquid (83) enriched in CH₄.

The liquid fraction (71) is sent to a level of the distillation column above the level at which the vaporized liquid enriched in CH₄ (65) is introduced and the vaporized bottom stream and the liquid fraction enter into contact for ensuring distillation.

The gas flow enriched in O₂ and N₂ (70) drawn off from the head of the distillation column is decompressed in the valve from MP to LP and transfer its cold energy in the exchanger (59) on contact with CO₂ depleted gas flow (51). The LP gas flow obtained (74) serves for regenerating the PTSA (42, 43). The gas flow exiting from the bottom of the PTSA is loaded with CO₂ and O₂ and is sent to the oxidation unit (10). In the illustrated embodiment, the gas flow (58) is oxidized in a common oxidation unit (10) with the flow (37) resulting from the regeneration of the PSAs, loaded with CO₂, O₂ and VOCs.

As explained above, a portion (63) of the MP liquid enriched in CH₄ (71) drawn off a bottom of the distillation column is sent to the heat exchanger (59), where it is vaporized by exchange with CO₂purified gas flow (51) and form a first MP vaporized gas flow (75).

The LP liquid (83) enriched in CH₄ is discharged in the condenser (72) and sent to the subcooler (80) and is vaporized in the heat exchanger (59) to produce a LP gas flow (84) enriched in CH₄.

The LP gas flow (84) enriched in CH₄ is compressed in a compressor (85) to produce a second MP gas flow (86) enriched in CH₄.

The MP first and second gas flow (75, 85) enriched in CH₄ are mixed (87) in the same pipe.

The MP vaporized gas flow (87) comprises between 97 and 100% of methane and less than 3% O₂, preferably less than 1%. It is at a pressure of between 1 and 5 bars absolute, advantageously higher than bars absolute and at room temperature, typically between 273 and 313K, advantageously 288K.

When the MP single column distillation unit does not meet the oxygen pipeline specification, an additional treatment has to be done on the product.

The solution of the invention consists in adding an O₂ depletion unit that will remove oxygen from the RNG.

According to FIG. 1, The MP vaporized gas flow is directed to a deoxo (76) in order to deplete O₂ from said gas flow.

Practically, the deoxo comprises a bed containing a catalyst, especially a platinum-based catalyst. The bed is heated at a temperature below 500° C. advantageously between 130 and 300° C. by heating means which are included in the deoxo. The deoxo also comprises some air and/or liquid means for cooling the gas and advantageously a moisture separator.

The deoxo allows to obtain a gas containing less than 100 ppvm of O₂.

The O₂ depleted gas is then sent to a dryer, especially a TSA (77) comprising at least one adsorber loaded with adsorbents capable of reversibly adsorbing the majority of remaining H₂O for example a zeolite or alumina based catalyst.

Advantageously, at least two TSAs are used so as to be able to implement the process continuously. Indeed, when the first TSA is saturated with H₂O, it is substituted by the second TSA which has itself been previously regenerated. Preferably, the TSA(s) is/are heat regenerated by using natural external gas.

According to FIG. 1, the gas flow is finally compressed in a booster (78) at a pressure depending on the specification of the grid (79), typically between 10 and 15 bars for the gas supply network, between 80 and 100 bars for the gas transportation network.

As explained before, landfill gas upgrading is not easy, due to the presence of multiple impurities to remove in the raw biogas: CO₂, air gases (nitrogen and oxygen), water, VOCs, H₂S, siloxanes.

The applicant has introduced a technology that simplifies the landfill gas upgrading process into RNG. This patented technology (patent FR3046086, US2019/0001263) combines the benefit of the best process for CO₂ removal on one hand (multiple stages of gas permeation membranes), with the best process for nitrogen and oxygen removal on the other hand (cryogenic distillation).

The instant invention highlights the potential of combining those two technologies for landfill gas upgrading, by adapting another process of cryogenic distillation. The choice between the cryogenic distillation (LP column versus single MP column) becomes a decision of economics (CAPEX and OPEX). Additionally, and most importantly, the choice should take into account the ease of operation and the up-time of the unit. The more equipment there is in a process, the lower total up-time of the unit; and as a consequence, the lower the annual incomes.

1/ A facility for producing gaseous biomethane (78) by purifying biogas from landfill (1), comprising:
a compression unit (4) for compressing an initial gas flow of the biogas (1) to be purified,
a volatile organic compound (VOC) purification unit (5) arranged downstream of the compression unit (4) to receive the compressed initial flow of the biogas (19) and comprising at least one adsorber (20, 21) loaded with adsorbents capable of reversibly adsorbing VOCs to thereby produce a VOC-depleted gas flow (50);
a membrane separation unit (6) arranged downstream of the VOC purification unit (5) to receive the VOC-depleted gas flow and subject the VOC-depleted gas flow (50) to at least one membrane separation (37, 38) to partially separate the CO₂ and O₂ from the gas flow producing a methane rich retentate (41),
a CO₂ polishing unit (7) arranged downstream of the membrane separation unit (6) to receive the methane rich retentate (41) from the membrane (37, 38), wherein the CO₂ polishing unit (7) comprises at least one adsorber loaded with adsorbents capable of reversibly adsorbing the majority of remaining CO₂ from the methane rich retentate (41) to produce a CO₂-depleted gas flow (51);
a cryodistillation unit (8) comprising a heat exchanger (59) and a distillation column (61), arranged downstream of the CO₂ polishing unit (7) to receive the CO₂-depleted gas flow (51) and subject the CO₂-depleted gas flow (51) to a cryogenic separation to separate O₂ and N₂ from the CO₂-depleted gas flow and to produce a gas distillate (70),
wherein a booster (9) is arranged downstream the membrane separation unit (6) and upstream the cryodistillation unit (8) and the cryodistillation unit (8) comprises further a subcooler, the said cryodistillation unit (8) being capable to produce two methane enriched flows respectively a low pressure (LP) and a medium pressure (MP) methane enriched flows, and wherein it further comprises a compressor capable to compress the low pressure (LP) methane enriched flow in order to mix it with the medium pressure methane enriched flow, to produce a medium pressure methane enriched flow.

2/ A facility for producing gaseous biomethane by purifying biogas from landfill according to claim 1, characterized in that the booster is arranged downstream the membrane unit and upstream the CO₂ polishing unit.

3/ A facility for producing gaseous biomethane by purifying biogas from landfill according to claim 1, characterized in that the booster is arranged downstream the CO₂ polishing unit and upstream the distillation unit.

4/ A facility for producing gaseous biomethane by purifying biogas from landfill according to claim 1, characterized in that it further comprises an O₂ depletion unit arranged downstream the cryodistillation unit to receive the medium pressure methane enriched flow capable of converting the O₂ present in medium pressure methane enriched flow into CO₂ and H₂O to produce an O₂ depleted gas flow, and a dryer arranged downstream the O₂ depletion unit capable of removing H₂O from the O₂ depleted gas flow.

5/ A facility for producing gaseous biomethane by purifying biogas from landfill according to claim 4, characterized in that the dryer (77) is a TSA (Temperature Swing Adsorption).

6/ A facility for producing gaseous biomethane by purifying biogas from landfill according to claim 4, characterized in that it further includes a booster arranged downstream the dryer.

7/ A facility for producing gaseous biomethane by purifying biogas from landfill according to claim 2, characterized it further includes an O₂ depletion unit (76) arranged downstream the booster and upstream the CO₂ polishing unit.

8/ A facility for producing gaseous biomethane by purifying biogas from landfill according to claim 7, characterized in that the CO₂ polishing unit (7) comprises at least one adsorber loaded with adsorbents capable of reversibly adsorbing the majority of remaining H₂O contained in the O₂ depleted gas flow.

9/ A facility for producing gaseous biomethane by purifying biogas from landfill according to claim 1, characterized in that the volatile organic compound (VOC) purification unit is a pressure swing adsorber (PSA).

10/ A facility for producing gaseous biomethane by purifying biogas from landfill according to claim 1, characterized in that the CO₂ polishing unit is a Pressure Temperature Swing Adsorption (PTSA).
